(19) United States
(12) Patent Application Publication
(10) Pub. No.: US 2012/0167102 A1
(43) Pub. Date: Jun. 28, 2012

(54) TAG-BASED DATA PROCESSING APPARATUS AND DATA PROCESSING METHOD THEREOF

(75) Inventor: Chia-Ming CHANG, Yonghe City (TW)

(73) Assignee: INSTITUTE FOR INFORMATION INDUSTRY, Taipei (TW)

(21) Appl. No.: 13/038,857

(22) Filed: Mar. 2, 2011

(30) Foreign Application Priority Data
Dec. 22, 2010 (TW) 099145274

(51) Int. Cl. G06F 9/46

(52) U.S. Cl. 718/102

(57) ABSTRACT

A data processing apparatus and a data processing method thereof are provided. The data processing apparatus comprises the buffers, the scheduler and the process nodes. The buffer stores the processed data and unprocessed data about the process nodes. The scheduler uses a tag to indicate the data is in which process and location, and puts the data into the process. The process node actively retrieves the data from the buffer according to the tag, and processes and stores the data in the buffer. By assigning the tag of the data, the data process flow can be established to form a data process pipeline.

This application claims priority to Taiwan Patent Application No. 099145274 filed on Dec. 22, 2010, which is hereby incorporated by reference in its entirety.

### FIELD

The present invention relates to a tag-based data processing apparatus and a tag-based data processing method thereof. More particularly, the present invention relates to a tag-based data processing apparatus that operates according to a tag-based data processing method thereof.

### BACKGROUND

Nowadays, almost all aspects of people's daily life are closely related to advancement of science and technology. In movies and video games, the so-called two-dimensional (2D) or three-dimensional (3D) animations are often found. As the imaging technologies become increasingly sophisticated, various kinds of animations also become more and more realistic to real-world scenes in real life, examples of which are people's facial expressions, variations in light and shade of water surfaces and surface gloss of objects. Accordingly, in order to present the real-world scenes in a realistic way, a great operational burden is imposed on central processing units (CPUs). To ease the operational burden on the CPUs in image processing, graphic processing units (GPUs) have been proposed.

A GPU mainly has the functions of transform and lighting (T&L), cubic environment mapping and vertex blending, texture compression and bump mapping, dual-texture four-pixel 256-bit rendering and the like. By use of the GPUs, the operational burden on the CPUs in image processing is greatly eased. Moreover, to further optimize 2D and 3D animations, multi-core GPUs have been commercially available. However, conventional scheduling technologies for the multi-core GPUs are mostly inefficient and inflexible, which degrades values of the multi-core GPUs significantly.

Accordingly, a need still exists in the art to effectively improve performance of a multi-core GPU by reasonably distributing operations among individual cores and making a compromise between performance and flexibility, so as to increase the additional values of this industry.

### SUMMARY

An objective of the present invention is to provide a data processing apparatus and a data processing method thereof. When an operation needs to be made on a data, the data processing apparatus schedules the data and generates a tag for use as an indication in processing of the data so that the operation can be made on the data efficiently.

To achieve the aforesaid objective, a data processing apparatus of the present invention comprises a plurality of buffers, scheduler electrically connected to the buffers, and a plurality of process nodes electrically connected to the scheduler and the buffers. The buffer is configured to store a data. The scheduler is configured to schedule the data into a process and generate a tag for indicating that the data has been scheduled into the process. The process node is configured to actively retrieve the data from the buffer and process the data according to the tag. By the way of assigning the data tag, the beginning and end of processing data are connected with each other to form a data process pipeline.

To achieve the aforesaid objective, a data processing method of the present invention is adapted for the data processing apparatus and comprises the following steps of: (a) enabling the scheduler to schedule the first data into a process; (b) enabling the scheduler to generate a first tag for indicating that the first data has been scheduled into the process; (c) enabling the process node to actively retrieve the first data from the buffer according to the first tag; (d) enabling the process node to process the first data; and (e) enabling the process node to store the second data of the buffer according to the first tag.

According to the above descriptions, the present invention schedules a data into a process and generates a tag. Then, hardware required for processing the data will operate according to the tag; for example, the process node can actively retrieve the data from the buffer according to the tag. Thereby, the present invention can operate the hardware required for processing the data in a more efficient way, and overcome the shortcoming of the prior art that a compromise cannot be made between performance and flexibility.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first preferred embodiment of the present invention

FIGS. 2A-2C are the schematic views of the states in processing data;

FIG. 3 is a schematic view of the scalable architecture of the first preferred embodiment;

FIG. 4 is a schematic view of the unified architecture of the first preferred embodiment;

FIG. 5 is a schematic view of the universal architecture of the first preferred embodiment;

FIG. 6 is a schematic view of the pixel-recorder architecture of the first preferred embodiment; and

FIG. 7 is a flowchart of a second preferred embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements not directly related to the present invention are omitted from depiction; and dimensional relationships among individual elements in the attached drawings are illustrated only for ease of understanding but not to limit the actual scale.

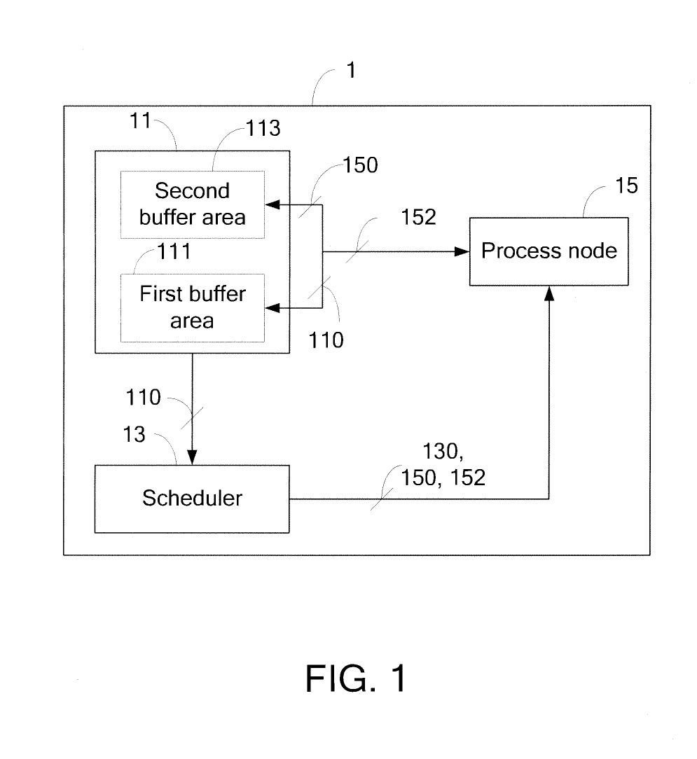

A first preferred embodiment of the present invention is shown in FIG. 1, which is a schematic view of a data processing apparatus 1. As can be seen from FIG. 1, the data processing apparatus 1 comprises a buffer 11, a scheduler 13 and a process node 15. The process node 15 is electrically connected to the buffer 11 and the scheduler 13, and the buffer 11 is further electrically connected to the scheduler 13. It shall be noted that, the data processing apparatus 1 is adapted for a graphic processing unit (GPU) and cooperates with other electronic components in the GPU; and the buffer 11, the scheduler 13 and the process node 15 are a buffer, a scheduler and a shader that can operate in the GPU respectively. Hereinbelow, functions of the individual components of the data processing apparatus 1 will be further described.

The buffer 11 of the data processing apparatus 1 of this embodiment comprises a first buffer area 111 and a second buffer area 113. The first buffer area 111 is configured to store a first data 110 that has not been processed, e.g., vertices and pixels that have not been shaded in a 3D image; and the second buffer area 113 is configured to store media data that have already been processed, e.g., vertices and pixels that have already been shaded in the 3D image.

When learning that the first data 110 needs to be shaded, the scheduler 13 schedules the first data 110 into a process (e.g., a shading process) according to a current usage status of hardware resources and generates a first tag 130. It shall be noted that, apart from indicating that the first data 110 has been scheduled into the process, the first tag 130 is further configured to indicate that the first data 110 shall be stored back into the second buffer area 113 of the buffer 11 after being shaded; in other words, the first tag 130 is configured to indicate any processing and actions that need to be made on the first data 110 during the shading process, but is not merely limited to indicating that the first data 110 has been scheduled into the process and shall be stored back into the second buffer area 113 of the buffer 11 after being shaded.

After generation of the first tag 130, the process node 15 actively retrieves the first data 110 from the first buffer area 111 of the buffer 11 and shades the first data 110 according to the first tag 130 to generate a second data 150 (e.g., the first data 110 that has been shaded). As compared to the conventional scheduling technology in which the process node is only allowed to passively receive and process a data, the process node 15 can actively retrieve from the first buffer area 111 of the buffer 11 and process the first data 110 according to the first tag 130.

After processing of the first data 110 is completed and a second data 150 is generated, the process node 15 generates a second tag 152, which indicates that processing of the first data 110 has been completed, for use in a subsequent process. More specifically, if subsequent processing is necessary for the second data 150, other hardware can learn from the second tag 152 that processing of the first data 110 has been completed and the second data 150 has been generated and can also learn the position where the second data 150 is stored.

Furthermore, after processing of the first data 110 is completed and a second data 150 is generated, the process node 15 can also learn from the first tag 130 that the second data 150 shall be stored back into the second buffer area 113 of the buffer 11. Accordingly, the process node 15 stores the second data 150 back into the second buffer area 113 of the buffer 11 according to the first tag 130.

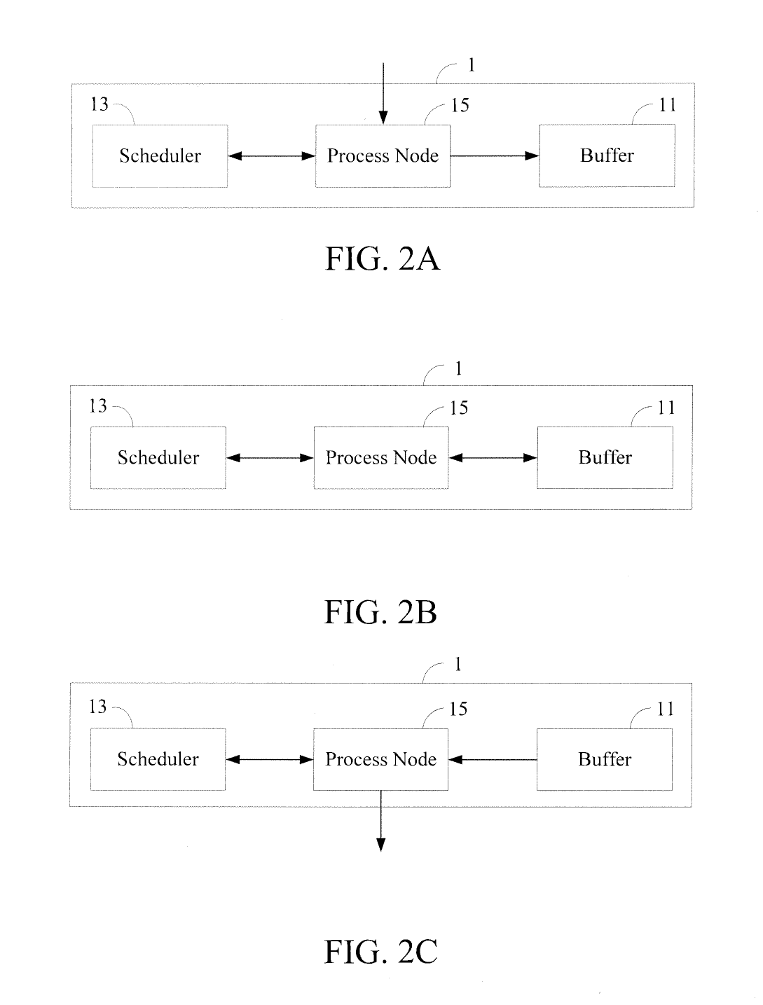

Specifically, the present invention may be divided into three modes according to the state of processing data. Please refer to FIGS. 2A-2C, which are schematic views of the states in processing data. FIG. 2A shows that when the data is not loaded into the data processing apparatus 1, the process node 15 may load and store the data into the buffer 11. The process node 15 or scheduler 13 will generate a tag indicating some information, such as the source/destination and process order of the data.

Please refer to FIG. 2B, the scheduler 13 may generate a tag indicating that which process should be adopted to process the data when the data is loaded into the data processing apparatus I and in processing. The process node 15 may be aware of where the data is according to the tag and retrieve the data from the buffer 11. The process node 15 further processes the data, and stores the processed data back into the buffer 11.

Finally, please refer to FIG. 2C. After all processes of the data are completed, the scheduler 13 generates a tag indicating the data can be output. The process node 15 can retrieve and output the processed data from the buffer 11 according to the tag indicating the data can be output. The present invention relates to a communication framework, which is implemented by the tag flow, to complete all processes of the data.

Furthermore, there are four hardware architectures for GPU: unified architecture, scalable architecture, universal architecture and pixel-recorder architecture. The data processing apparatus 1 of the present invention is compatible to the above four architectures and bring the efficiency of the above four architectures into full play via the tag flow framework. In the following description, the process node 15 is a shader to explain how the present invention apply to the above four architectures.

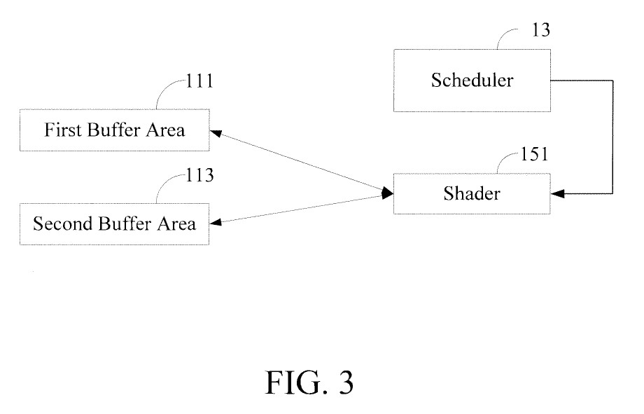

Please refer to FIG. 3, which is a schematic view of the scalable architecture. If the scalable architecture only comprises one shader 151, the scheduler 13 or shader 151 may generate the tag indicating the process and storage location of the data, which is not processed, of the first buffer area 111. The shader 151 can actively retrieve and process the data, which is not processed, from the first buffer area 111 according to the tag. After processing, the processed data is stored back into second buffer area 113 or output to the outside.

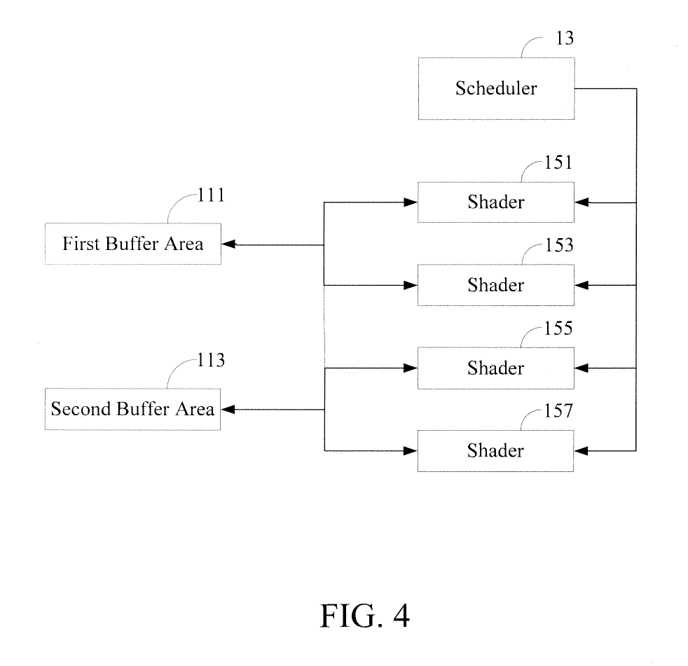

If the scalable architecture comprises a plurality of shaders (such as the shaders 151, 153, 155 and 157), it can be considered as the unified architecture (shown in FIG. 4) and its data process is controlled by the tag flow. It should be noted that the difference between the unified and scalable architectures is that the hardware resource of the unified architecture is fixed, and the hardware resource of the scalable architecture can be adjusted according to the practice needs. The unified and scalable architectures both can be controlled by the tag flow.

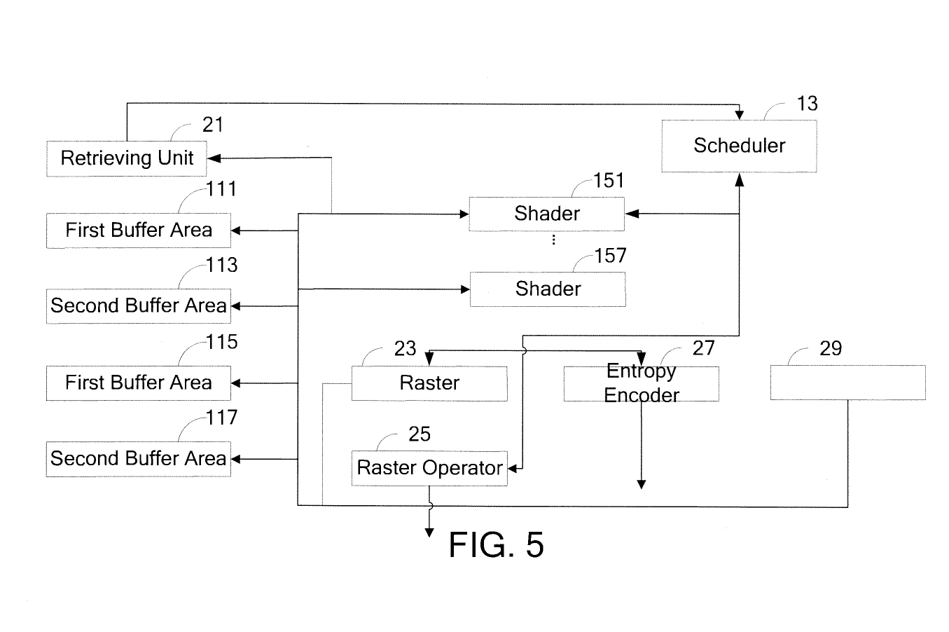

Please refer to FIG. 5, which is a schematic view of the universal architecture comprising a retrieving unit 21, the first buffer areas 111 and 115, the second buffer areas 113 and 117, the scheduler 13, the shaders 151, 153, 155 and 157, the raster 23, the raster operator 25, the entropy encoder 27 and other hardware 29. The first buffer areas 111 and 115 are configured to store the unshaded vertexes and pixels. The second buffer areas 113 and 117 are configured to store the shaded vertexes and pixels.

Comparing with the conventional universal architectures, the shaders 151, 153, 155 and 157 based on the universal architecture of the present invention may be controlled by the tag flow to actively retrieve the unshaded vertexes and pixels from the first buffer areas 111 and 115. After shading, the shaders 151, 153, 155 and 157 store the shaded vertexes and pixels back into the second buffer areas 113 and 117. The raster 23, the raster operator 25, the entropy encoder 27 and other hardware 29 are also controlled by the tag flow to complete the corresponding processes.

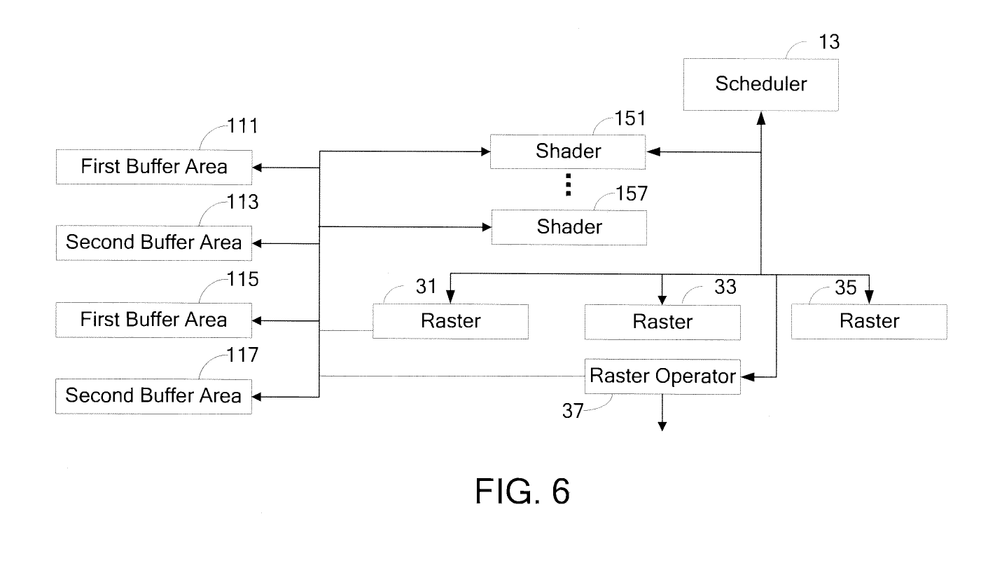

Please refer to FIG. 6, which is a schematic view of the pixel-recorder architecture comprising the first buffer areas 111 and 115 the second buffer areas 113 and 117, the scheduler 13, the shaders 151, 153, 155 and 157, the rasters 31, 33 and 35 and the raster operator 37. The first buffer areas 111 and 115 are configured to store the unshaded vertexes and pixels. The second buffer areas 113 and 117 are configured to store the shaded vertexes and pixels.

Comparing with the conventional pixel-recorder architectures, the shaders 151, 153, 155 and 157 based on the pixel-recorder architecture of the present invention may be controlled by the tag flow to actively retrieve the unshaded vertexes and pixels from the first buffer areas 111 and 115. After shading, the shaders 151, 153, 155 and 157 store the shaded vertexes and pixels back into the second buffer areas 113 and 117. The rasters 31, 33, 35 and raster operator 37 are also controlled by the tag flow to complete the corresponding processes (such as sorting the output pixels according to the tag to make them back to their triangles).

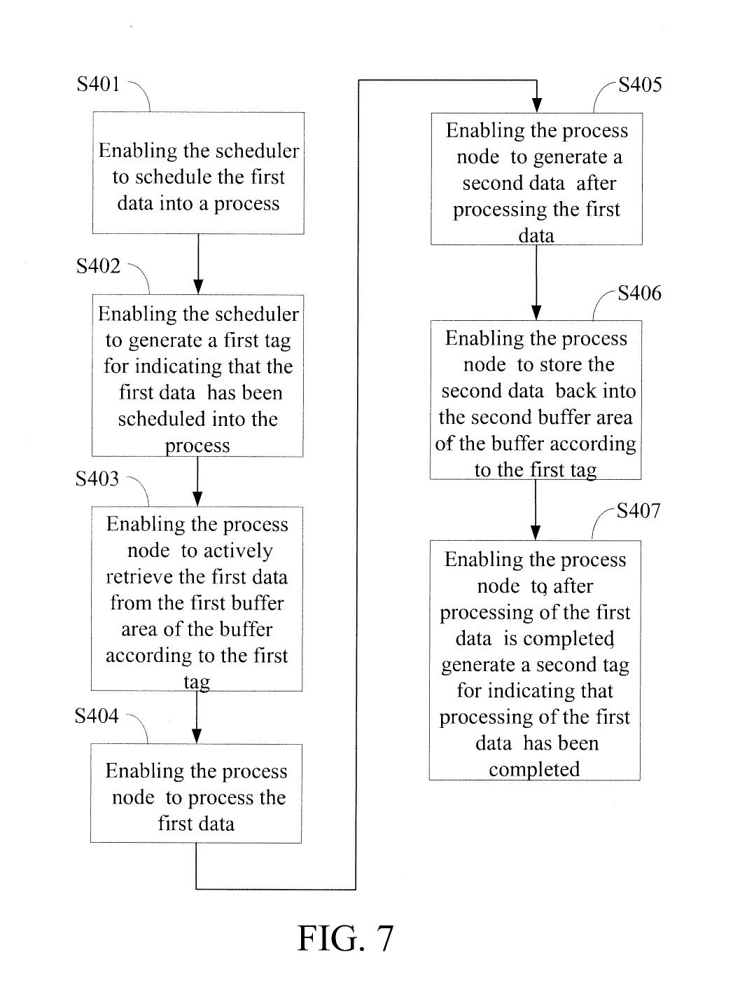

A second preferred embodiment of the present invention is shown in FIG. 7, which is a flowchart of a data processing method for a data processing apparatus as described in the first embodiment. The data processing apparatus comprises a buffer, a scheduler and a process node. The process node is electrically connected to the buffer and the scheduler, and the buffer is further electrically connected to the scheduler. The buffer comprises a first buffer area and a second buffer area. The first buffer area is configured to store a first data that has not been processed, e.g., vertices and pixels that have not been shaded in a 3D image; and the second buffer area is configured to store media data that have already been processed, e.g., vertices and pixels that have already been shaded in the 3D image.

Firstly, step S401 is executed to enable the scheduler to schedule the first data into a process; and step S402 is executed to enable the scheduler to generate a first tag for indicating that the first data has been scheduled into the process. It shall be noted that, apart from indicating that the first data has been scheduled into the process, the first tag is further configured to indicate that the first data shall be stored back into the second buffer area of the buffer after being shaded. In other words, the first tag is configured to indicate any processing and actions that need to be made on the first data during the shading process, but is not merely limited to indicating that the first data has been scheduled into the process and shall be stored back into the second buffer area of the buffer after being shaded.

After generation of the first tag, step S403 is executed to enable the process node to actively retrieve the first data from the first buffer area of the buffer according to the first tag, and step S404 is executed to enable the process node to process the first data. As compared to the conventional scheduling technology in which the process node is only allowed to passively receive and process a data, the data processing method of this embodiment can enable the process node to actively retrieve from the first buffer area of the buffer and process the first data according to the first tag.

Next, step S405 is executed to enable the process node to generate a second data after processing the first data, and step S406 is executed to enable the process node to store the second data back into the second buffer area of the buffer according to the first tag. In detail, the data processing method of this embodiment can enable the process node to further learn from the first tag that the second data shall be stored back into the second buffer area of the buffer. Accordingly, the process node stores the second data back into the second buffer area of the buffer according to the first tag.

Finally, step S407 is executed to enable the process node to, after processing of the first data is completed, generate a second tag, which indicates that processing of the first data has been completed, for use in a subsequent process. More specifically, if subsequent processing is necessary for the second data, other hardware can learn from the second tag that processing of the first data has been completed and the second data has been generated and can also learn the position where the second data is stored.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

According to the above descriptions, the present invention schedules a data into a process and generates a tag. Then, hardware required for processing the data will operate according to the tag; for example, the process node can actively retrieve the data from the buffer according to the tag. Thereby, the present invention can operate the hardware required for processing the data in a more efficient way, and overcome the shortcoming of the prior art that a compromise cannot be made between performance and flexibility.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data processing apparatus, comprising:
a buffer, being configured to store a first data;
a scheduler electrically connected to the buffer, being configured to schedule the first data into a process and generate a first tag for indicating that the first data has been scheduled into the process; and
a process node electrically connected to the scheduler and the buffer, being configured to actively retrieve the first data from the buffer and process the first data according to the first tag.

2. The data processing apparatus as claimed in claim 1, wherein the first tag is further configured to indicate that the first data shall be stored back into the buffer after being processed, and the process node generates a second data after processing the first data and further stores the second data back into the buffer according to the first tag.

3. The data processing apparatus as claimed in claim 2, wherein the buffer comprises a first buffer area and a second buffer area, the first buffer area is configured to store the first data, the process node actively retrieves the first data from the first buffer area of the buffer and processes the first data according to the first tag to generate the second data, and the process node further stores the second data back into the second buffer area of the buffer according to the first tag.

4. The data processing apparatus as claimed in claim 1, wherein the process node is further configured to, after processing of the first data is completed, generate a second tag, which indicates that processing of the first data has been completed, for use in a subsequent process.

5. A data processing method for a data processing apparatus, wherein the data processing apparatus comprises a buffer, a scheduler and a process node electrically connected to the buffer and the scheduler, and the buffer is configured to store a first data, the data processing method comprising the following steps of:
(a) enabling the scheduler to schedule the first data into a process;
(b) enabling the scheduler to generate a first tag for indicating that the first data has been scheduled into the process;
(c) enabling the process node to actively retrieve the first data from the buffer according to the first tag; and
(d) enabling the process node to process the first data.

6. The data processing method as claimed in claim 5, wherein the first tag is further configured to indicate that the first data shall be stored back into the buffer after being processed, the data processing method further comprising the following steps of:
(e) enabling the process node to generate a second data after processing the first data; and
(f) enabling the process node to store the second data back into the buffer according to the first tag.

7. The data processing method as claimed in claim 6, wherein the buffer comprises a first buffer area and a second buffer area, the first buffer area is configured to store the first data, the step (c) is a step of enabling the process node to actively retrieve the first data from the first buffer area of the buffer according to the first tag, and the step (f) is a step of enabling the process node to store the second data back into the second buffer area of the buffer according to the first tag.

8. The data processing method as claimed in claim 5, further comprising a step of enabling the process node to, after processing of the first data is completed, generate a second tag, which indicates that processing of the first data has been completed, for use in a subsequent process.
